(19) United States
(12) Patent Application Publication
(10) Pub. No.: US 2018/0049845 A1
(43) Pub. Date: Feb. 22, 2018

(54) Endodontic Instrument & Method for Fabricating Endodontic Instrument Using Additive Manufacturing Process

(71) Applicant: John T. McSpadden, Lookout Mountain, TN (US)

(72) Inventor: John T. McSpadden, Lookout Mountain, TN (US)

(21) Appl. No.: 15/680,785

(22) Filed: Aug. 18, 2017

Related U.S. Application Data
(60) Provisional application No. 62/376,996, filed on Aug. 19, 2016.

(51) Int. Cl. A61C 5/42; B24B 19/02; B24B 19/04

(52) U.S. Cl. CPC A61C 5/42; B24B 19/04; B24B 19/022

(57) ABSTRACT

A method of manufacturing an endodontic instrument includes providing a metal alloy powder and forming an endodontic instrument by depositing and heating successive layers of the metal alloy poser according to an additive manufacturing process. Forming an endodontic instrument according to an additive manufacturing process allows for advanced features such as one or more voids in the interior region of the instrument.

### CROSS-REFERENCE TO RELATED APPLICATION

This application claims priority as a non-provisional to co-pending U.S. Provisional Application Ser. No. 62/376,996 filed Aug. 19, 2016, entitled “Endodontic Instrument & Method for Fabricating Endodontic Instrument Using Additive Manufacturing Process,” the contents of which is incorporated herein by reference.

### FIELD

This disclosure relates to the field of dentistry. More particularly, this disclosure relates to endodontic instruments and a method for fabricating endodontic instruments using an additive manufacturing process.

### BACKGROUND

In the field of endodontics, one of the most important and delicate procedures is that of cleaning or extirpating a root canal to provide a properly dimensioned cavity while essentially maintaining the central axis of the canal. This step is important in order to enable complete filling of the canal without any voids and in a manner which prevents the entrapment of noxious tissue in the canal as the canal is being filled.

In a root canal procedure, the dentist removes injured tissue and debris from the canal prior to filling the canal with an inert filling material. In performing this procedure, the dentist must gain access to the entire canal, shaping it as necessary. But root canals normally are very small in diameter, and they are usually quite curved. It is therefore very difficult to gain access to the full length of a root canal.

Many tools have been designed to perform the difficult task of cleaning and shaping root canals. Historically, dentists have used a wide multitude of tools to remove the soft and hard tissues of the root canal. Traditionally, these tools, usually called endodontic files, have been made by three basic processes. In one process, a file is created by twisting a prismatic rod of either square or triangular cross section in order to create a file with helical cutting/abrading edges (“K-file”). The second process involves grinding helical flutes into a circular or tapered rod to create a file with one or more helical cutting edges (also known as a “K-file”). The third method involves “hacking” or rapidly striking a circular or tapered rod with a blade at a given angle along the length of the rod, thus creating an endodontic file characterized by a plurality of burr-like barbs or cutting edge projections (“barbed file” or “broach”). Each of these methods produces an instrument having unique attributes, advantages, and disadvantages.

Endodontic files have historically been made from stainless steel, but due to the inherent stiffness and brittleness of steel, these tools can sometimes pose a significant danger of breakage in the curved root canal. More recent designs have attempted to overcome these problems. Some attempt to alter the geometry of the stainless steel file or use a more flexible material, such as nickel-titanium alloys, in order to provide more flexibility. While these approaches have improved the performance of endodontic files, the files still have a tendency to break if over-torqued or fatigued.

Additionally, when a helically fluted endodontic file is used to extirpate a canal, debris tends to accumulate in the helical flutes as the procedure progresses. This accumulated debris can decrease the files efficiency and can eventually prevent the cutting edges on the file from engaging the canal wall. One method for alleviating the debris accumulation is frequent irrigation of the canal. In certain instances, it is preferable to irrigate the canal simultaneously with the extirpation process. However, this can be difficult when the canal is substantially filled with an endodontic file.

What is needed, therefore, is a different geometric approach to create an endodontic instrument which would fare better with regard to torque stresses, fatigue, and other related stresses on such an instrument, limit debris accumulation, and allow for irrigation simultaneously with extirpation of a root canal. Additionally, what are needed are new methods for manufacturing endodontic instruments with such desirable characteristics.

### SUMMARY

The disclosure advantageously provides a method of manufacturing an endodontic instrument including providing a metal alloy powder and forming an endodontic instrument by depositing and heating successive layers of the metal alloy powder according to an additive manufacturing process. According to certain embodiments, the metal alloy powder comprises nickel-titanium alloy powder particles. In some embodiments, the metal alloy powder includes a first metal alloy powder and a second metal alloy powder. The second metal alloy powder has a different composition than the first metal alloy powder, and the forming step includes depositing and heating the first metal alloy powder to form a first portion of the endodontic instrument and depositing and heating the second metal alloy powder to form a second portion of the endodontic instrument.

According to certain embodiments, the endodontic instrument includes one or more voids disposed within a working portion of the endodontic instrument. In some embodiments, the one or more voids are devoid of any filler material. In other embodiments, at least a portion of the one or more voids include a trellis filled frame.

According to certain embodiments, the one or more voids are disposed in an only an upper portion of the working portion; the one or more voids extend longitudinally along at least a portion of a length of the working portion; the one or more voids extend laterally through the working portion of the instrument; and/or the one or more voids includes one or more voids in an upper working portion of the instrument and one or more voids in a lower working portion of the instrument, the one or more voids in the upper working portion having a larger cubic volume than the one or more voids in the lower working portion.

According to some embodiments, the endodontic instrument includes a plurality of helical lands and a plurality of voids, each of the plurality of voids extending helically along at least a portion of the length of the working portion adjacent one of the plurality of helical lands.

According to certain embodiments, the endodontic instrument includes a hollow core disposed along at least a portion of an axial center of the endodontic instrument. The endodontic instrument may also include one or more evacuation channels in fluid communication with the hollow core and extending to an outer periphery of the endodontic instrument.

According to another embodiment of the disclosure, an endodontic instrument includes a working portion having a length, the working portion including at least one helical flute and at least one helical land extending along the length of the working portion, and one or more voids disposed within the working portion for increasing the flexibility of the endodontic instrument. The endodontic instrument is formed by depositing and heating successive layers of a metal alloy powder according to an additive manufacturing process.

According to certain embodiments, the one or more voids are devoid of any filler material. In other embodiments, at least a portion of the one or more voids include a trellis filled frame. In some embodiments, the one or more voids are disposed in an only an upper portion of the working portion; the one or more voids extend longitudinally along at least a portion of a length of the working portion; the one or more voids extend helically along at least a portion of the length of the working portion adjacent one of the at least one helical lands; the one or more voids extend laterally through the working portion of the instrument; the one or more voids includes one or more voids in an upper working portion of the instrument and one or more voids in a lower working portion of the instrument, the one or more voids in the upper working portion having a larger cubic volume than the one or more voids in the lower working portion; and/or the one or more voids includes a hollow core disposed along at least a portion of an axial center of the endodontic instrument with one or more evacuation channels in fluid communication with the hollow core and extending to an outer periphery of the endodontic instrument.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a side view of a generic endodontic instrument; and

FIGS. 2-6 are cross-sectional views of endodontic instruments according to various embodiments of the disclosure.

### DETAILED DESCRIPTION

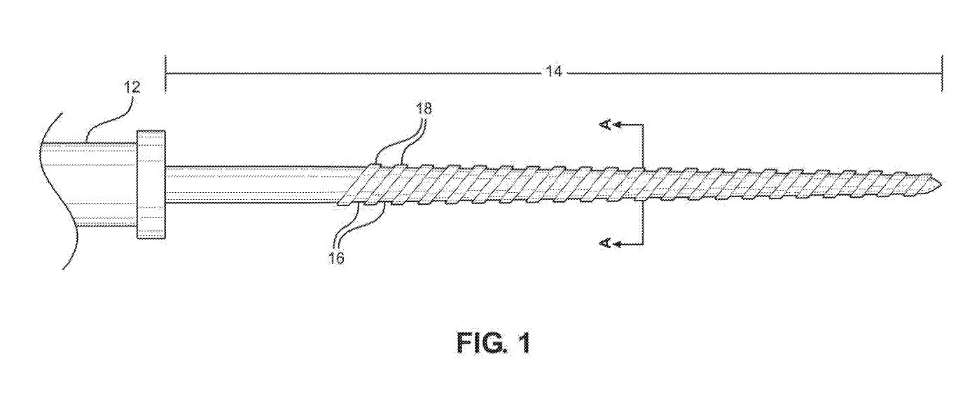

Referring to FIG. 1, an exemplary endodontic instrument 10 is shown having a head portion 12 at its proximal end and a shank-like working portion 14 at its distal end. The working potion 14 is preferably tapered. The head or driving end 12 of the file 10 is configured to mate with a chuck of a dental handpiece (not shown). Alternately, or in addition to the fitting mating configuration, the head 12 may include a knurled or otherwise treated surface to facilitate hand manipulation of the instrument 10. The working portion 14 is generally comprised of one or more helical flutes 16 defining radial lands/cutting edges 18 on the outer periphery of the working portion 14 of the instrument 10. Those skilled in the art will readily appreciate that various instruments can be configured with various flute 16 and cutting edge 18 configurations as desired.

The cutting edges of instrument 10 have traditionally been formed by cutting/grinding notches in an instrument black, e.g., moving a rotating instrument blank formed from the desired material past a grinding wheel to remove strips of material and form the flutes 16 and lands/blades 18 for the final instrument 10. As a result, only geometrical/symmetrical flutes 16 and lands 18 have generally been possible according to traditional fabrication methods for the instruments with the dimensions of the flutes 16 and lands 18 typically being limited by grinding wheels that are several inches in diameter.

According to the present disclosure, endontic instruments 10 are fabricated by additive manufacturing techniques. More specifically, the present disclosure involves the application and utilization of metal alloy powders that are deposited, heated, and melted in successive layers to efficiently form and shape endondotic instruments into improved and complex configurations that are not possible, or at least are very difficult, using traditional manufacturing techniques described above. In other words, because a structure's geometric complexity has little impact on the fabrication process using additive manufacturing, the present disclosure provides attractive but complex features that are able to be efficiently fabricated into endodontic instruments when using additive manufacturing processes to fabricate the instruments.

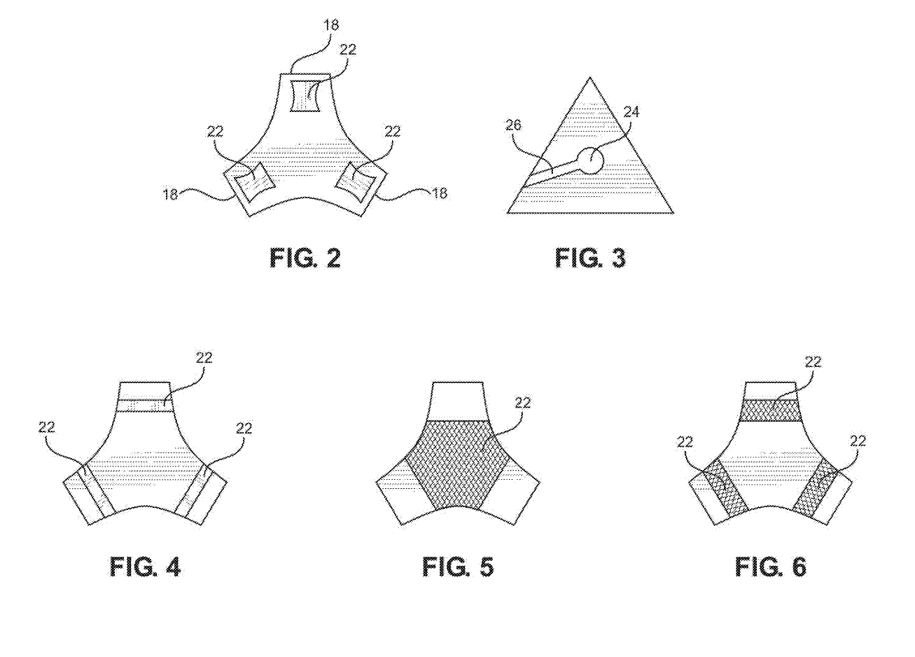

Referring to FIGS. 2-6, cross-sectional views of exemplary instrument configurations taken along section A-A of FIG. 1 are shown according to certain embodiments of the disclosure. While the overall external shapes of these depicted instrument configurations are known in the art, they include certain internal features that cannot generally be formed using grinding wheels or other known techniques for forming flutes from instrument blanks as described in the background herein. However, by fabricating the instruments 10 using an additive manufacturing technique, the advanced features described below can be implemented into the instruments to improve certain characteristics.

For example, as shown in FIG. 2, instrument 10 includes voids, indentions, apertures, gaps, etc. (hereinafter collectively referred to as “voids”) 22, preferably adjacent the outer periphery of the working portion 14 adjacent the blades 18. According to certain embodiments, the voids 22 may extend longitudinally along at least a portion of the working portion 14 of the instrument 10. According to these embodiments, the voids 22 may extend helically at the same helix angle as the helical blades 18, or the voids 22 may extend substantially linearly according to the taper angle of the instrument 10 by moving the voids 22 closer to the axial center of the instrument 10. In certain embodiments, the voids 22 are absent of material. However, in other embodiments, the voids 22 include a trellis-like framework.

By including the one or more voids 22 in an internal portion of the working portion 14, the working portion 14 is able to be more flexible without changing or significantly decreasing the instrument's cutting ability. In fact, the voids 22 may actually increase the cutting ability while also increasing the flexibility. In certain embodiments, the voids 22 may be only disposed in a portion of the working portion 14 as desired to increase flexibility in that particular portion of the instrument 10. For example, for tapered instruments 10 generally having a greater flexibility as the diameter decreases towards the lower end of the working portion 14, voids 22 may be provided towards the upper end to increase flexibility in the working portion 14 having a greater diameter. Similarly, the size and/or frequency of the voids 22 may be increased at the upper end of the working portion 14 as compared to the lower end. In certain embodiments, the additive manufacturing process is used to vary the dimensions of the voids 22 along the length of the instrument 10. For example, for tapered instruments 10, the diameter of the voids 22 may decrease as they extend along the working portion 14 in relation to the tapering. Similarly, the cubic volume of the voids 22 in the upper working portion may be larger than the cubic volume of the voids 22 in the lower working portion.

In other examples, such as shown in FIGS. 3-5, rather than extending longitudinally along the working portion, the voids 22 may extend laterally across the instrument. As shown in FIG. 3, the voids may extend laterally through the blades of the helical lands 18. In other embodiments, the voids 22 may extend laterally through the center of the instrument. In further examples, trellis-like voids 22 may make up the entirety of certain portions in the interior of the working portion of the instrument 10. For example, such as shown in FIG. 4, the core of the instrument may have a trellis-like structured void 22 along the entire length of the instrument or a portion thereof In other embodiments, such as shown in FIG. 5, portions of the blades of the helical flutes may have a trellis-like structured void 22.

According to another embodiment of the disclosure, similar to providing voids 22 to increase flexibility in chosen areas of the working portion 14 of instrument 10 as described above, additive manufacturing is used to vary the metal alloy powders used at different areas of the working portion 14. In other words, fabricating instruments 10 using additive manufacturing processes permits a user to easily alter instrument 10 characteristics varying the alloy powder deposited on subsequent layers. For example, according to one exemplary embodiment, a stiffer alloy is deposited in the additive manufacturing process towards the lower end of the working portion 14, a more moderately stiff alloy is deposited towards the middle of the working portion 14, and a more flexible alloy is deposited towards the upper end of the working portion 14.

Referring to FIG. 6, according to another embodiment of the disclosure, an additive manufacturing process is used to provide a void in the form of a hollow core 24 disposed along the length of the instrument 10. According to this embodiment, a drill or other device attached to the endodontic instrument 10 provides a fluid or lubricating agent through the hollow core to provide irrigation of the root canal during the procedure. In some embodiments, the drill also provides means for withdrawing fluid and debris (i.e., tissue from the wall of the canal, bacteria, etc. removed from the canal by the cutting edges 18) from the root canal through the hollow core 24. In addition, a plurality of evacuation channels 26, each in fluid communication with the hollow core 24, may be provided along the length of the instrument 10 to enhance the lubrication or withdrawal by allowing the fluid or debris to pass through the channels 26 and up the hollow core 24 during withdrawal while down the hollow core 24 and out the channels 26 during lubrication.

According to certain embodiments, the additive manufacturing process is used to vary the dimensions of the hollow core 24 along the length of the instrument 10. For example, for tapered instruments 10, the diameter of the hollow core 24 may decrease in relation to the tapering. According to other embodiments, the diameter of the hollow core 24 may be varied to further enhance or restrict the lubrication/withdrawal described above in certain regions of the working portion 14 as desired.

It should be understood that using an additive manufacturing process for forming endodontic instruments permits fabrication of an endless variety of known and unknown flute/cutting edge design features. Further, additive manufacturing allows for different design features to be possible in different regions of the instrument 10. For example, in certain situations it may be desirable to include sharper cutting edges 18 towards the lower end than at the upper end of the instrument 10, or vice versa. In other situations, it may be desirable to include certain regions with radial lands while other regions include an active cutting edge. According to another embodiment, rather than having edges formed by voids 22, there may be blades formed by projections or appendages. This configuration can provide a central core that is flexible while having projections that are effective in cutting.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A method of manufacturing an endodontic instrument comprising:
providing a metal alloy powder; and
forming an endodontic instrument by depositing and heating successive layers of the metal alloy powder according to an additive manufacturing process.

2. The method of claim 1 wherein the metal alloy powder comprises nickel-titanium alloy powder particles.

3. The method of claim 1 wherein the metal alloy powder includes a first metal alloy powder and a second metal alloy powder having a different composition than the first metal alloy powder, the forming step including depositing and heating the first metal alloy powder to form a first portion of the endodontic instrument and depositing and heating the second metal alloy powder to form a second portion of the endodontic instrument.

4. The method of claim 1 wherein the endodontic instrument includes one or more voids disposed within a working portion of the endodontic instrument.

5. The method of claim 4 wherein the one or more voids are devoid of any filler material.

6. The method of claim 4 wherein at least a portion of the one or more voids include a trellis filled frame.

7. The method of claim 4 wherein the one or more voids are disposed in an only an upper portion of the working portion.

8. The method of claim 4 wherein the one or more voids extend longitudinally along at least a portion of a length of the working portion.

9. The method of claim 8 wherein the endodontic instrument includes a plurality of helical lands and a plurality of voids, each of the plurality of voids extending helically along at least a portion of the length of the working portion adjacent one of the plurality of helical lands.

10. The method of claim 4 wherein the one or more voids extend laterally through the working portion of the instrument.

11. The method of claim 4 wherein the one or more voids includes one or more voids in an upper working portion of the instrument and one or more voids in a lower working portion of the instrument, the one or more voids in the upper working portion having a larger cubic volume than the one or more voids in the lower working portion.

12. The method of claim 1 wherein the endodontic instrument includes a hollow core disposed along at least a portion of an axial center of the endodontic instrument.

13. The method of claim 10 wherein the endodontic instrument further includes one or more evacuation channels in fluid communication with the hollow core and extending to an outer periphery of the endodontic instrument.

14. An endodontic instrument comprising:
a working portion having a length, the working portion including at least one helical flute and at least one helical land extending along the length of the working portion; and
one or more voids disposed within the working portion for increasing the flexibility of the endodontic instrument,
wherein the endodontic instrument is formed by depositing and heating successive layers of a metal alloy powder according to an additive manufacturing process.

15. The endodontic instrument of claim 14 wherein the one or more voids are devoid of any filler material.

16. The endodontic instrument of claim 14 wherein at least a portion of the one or more voids include a trellis filled frame.

17. The endodontic instrument of claim 14 wherein the one or more voids are disposed in an only an upper portion of the working portion.

18. The endodontic instrument of claim 14 wherein the one or more voids extend longitudinally along at least a portion of a length of the working portion.

19. The endodontic instrument of claim 18 wherein the one or more voids extend helically along at least a portion of the length of the working portion adjacent one of the at least one helical lands.

20. The endodontic instrument of claim 14 wherein the one or more voids extend laterally through the working portion of the instrument.

21. The endodontic instrument of claim 14 wherein the one or more voids includes one or more voids in an upper working portion of the instrument and one or more voids in a lower working portion of the instrument, the one or more voids in the upper working portion having a larger cubic volume than the one or more voids in the lower working portion.

22. The endodontic instrument of claim 14 wherein the one or more voids includes a hollow core disposed along at least a portion of an axial center of the endodontic instrument.

23. The endodontic instrument of claim 22 further comprising one or more evacuation channels in fluid communication with the hollow core and extending to an outer periphery of the endodontic instrument.
